(19) United States
(12) Patent Application Publication
(10) Pub. No.: US 2003/0058530 A1
(43) Pub. Date: Mar. 27, 2003

(54) Microscope switchable between observation modes

(76) Inventor: Yoshihiro Kawano, Tokyo (JP)

Correspondence Address: KENYON & KENYON, 1500 K STREET, N.W., SUITE 700, WASHINGTON, DC, 20005, US

(21) Appl. No.: 10/253,475

(22) Filed: Sep. 25, 2002

(30) Foreign Application Priority Data
Sep. 25, 2001 (JP) 2001-290943

(51) Int. Cl. G02B 21/00

(52) U.S. Cl. 359/385; 359/368; 359/381; 359/388; 359/636

(57) ABSTRACT

A high-performance microscope allows total internal reflection fluorescence microscopy, fluorescence microscopy and interference reflection microscopy (or reflection contrast microscopy) to be selectively performed by using the same objective. The microscope has an objective optical system and an image-forming optical system for imaging light from a sample passing through the objective optical system onto an image pickup device. An optical member is provided in a viewing optical path extending from the objective optical system to the image-forming optical system. The optical member reflects illuminating light from an illuminating optical system so that the illuminating light enters the objective optical system, and allows the light from the sample passing through the objective optical system to pass through the image-forming optical system. The illuminating optical system is provided therein with a mechanism for adjusting an illuminating light collecting position on a pupil plane of the objective optical system in a direction perpendicular to an optical axis. The viewing optical path is provided therein with a wavelength selecting device for selecting an observation wavelength according to the illuminating light collecting position on the pupil plane of the objective optical system.

This application claims benefit of Japanese Application No. 2001-290943 filed in Japan on Sep. 25, 2001, the contents of which are incorporated by this reference.

### BACKGROUND OF THE INVENTION

1. Field of the Invention

The present invention relates to a microscope switchable between observation modes. More particularly, the present invention relates to a high-performance microscope allowing total internal reflection fluorescence microscopy, fluorescence microscopy and interference reflection microscopy (or reflection contrast microscopy) to be selectively performed by using the same objective.

2. Discussion of Related Art

Hitherto, various microscopic observation methods have been developed. However, the microscopic observation methods cannot readily be switched from one to another to obtain the best optical performance for detection of molecules or for observation of living organisms, cells, eggs, etc. with a single microscope. For example, it has heretofore been not easy to switch from fluorescence microscopy to total internal reflection fluorescence microscopy [for example, see Japanese Patent Application Unexamined Publication (KOKAI) No. Hei 9-159922], or from total internal reflection fluorescence microscopy to interference reflection microscopy or reflection contrast microscopy (for example, see German Patent Application Laid-Open No. 2,626,540), or from fluorescence microscopy to interference reflection microscopy (or reflection contrast microscopy). It has also been very difficult to switch between these microscopic observation methods at multiple wavelengths. However, it is demanded that various observation methods should be readily switchable from one to another to obtain the best optical performance when it is desired to continue observation of the same sample, for example, when the user needs to observe changes occurring in a certain molecule when another molecule is added thereto, or changes of cells when stimulated, or to perform time-lapse observation for a long period of time. It is also demanded that microscopic observation methods using multiple wavelengths should be readily switchable from one to another.

### SUMMARY OF THE INVENTION

The present invention was made in view of the present state of the art as stated above.

An object of the present invention is to provide a high-performance microscope allowing total internal reflection fluorescence microscopy, fluorescence microscopy and interference reflection microscopy (or reflection contrast microscopy) to be selectively performed by using the same objective.

To attain the above-described object, the present invention provides a microscope switchable between observation modes. The microscope has an objective optical system and an image-forming optical system for imaging light from a sample passing through the objective optical system onto an image pickup device. An optical member is provided in a viewing optical path extending from the objective optical system to the image-forming optical system. The optical member reflects illuminating light from an illuminating optical system so that the illuminating light enters the objective optical system, and allows the light from the sample passing through the objective optical system to pass through the image-forming optical system. The illuminating optical system is provided therein with a mechanism for adjusting an illuminating light collecting position on a pupil plane of the objective optical system in a direction perpendicular to an optical axis. Moreover, the viewing optical path is provided therein with a wavelength selecting device for selecting an observation wavelength according to the illuminating light collecting position on the pupil plane of the objective optical system.

In this case, it is desirable that a total reflection return light cut-off device for cutting off totally reflected return light in total internal reflection fluorescence microscopy observation should be disposed in the vicinity of the pupil plane of the objective optical system.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a diagram showing the arrangement of a microscope system according to a first embodiment of the present invention.

FIG. 2 is a diagram showing the arrangement of a light source unit for use in the first embodiment.

FIG. 3(a) is a sectional view showing the arrangement of an objective used in the first embodiment.

FIG. 3(b) is a plan view showing a total reflection return light cut-off device used in the first embodiment.

FIG. 4 is a diagram showing the arrangement of a microscope system according to a second embodiment of the present invention.

FIG. 5 is a diagram showing the arrangement of a microscope system according to a third embodiment of the present invention.

FIGS. 6(a) and 6(b) are diagrams for describing the configuration and operation of a stop plate used in the third embodiment.

FIG. 7 is a diagram showing the arrangement of a microscope system according to a fourth embodiment of the present invention.

### DESCRIPTION OF THE PREFERRED EMBODIMENTS

First, the basic concept of the microscope switchable between observation modes according to the present invention will be described.

It has heretofore been necessary to use objectives of different NA (Numerical Aperture) in order to obtain the best optical performance in fluorescence microscopy, total internal reflection fluorescence microscopy, and interference reflection microscopy (or reflection contrast microscopy).

To obtain the best fluorescence microscopic image, an objective having an NA not less than 1.33 and less than 1.38 is needed. The reason for this is as follows. In the case of incident-light fluorescence illumination, if excitation light is totally reflected between the sample and the cover glass, the reflected light becomes return light toward the image. This causes the image contrast to be degraded unfavorably. Usually, a fluorescence microscope contains a band-pass filter (excitation filter) that transmits only excitation light. However, totally reflected bright excitation light cannot completely be cut off by the excitation filter but slightly leaks to reach the image plane, causing the image contrast to be degraded.

In the case of total internal reflection fluorescence microscopy, total reflection is caused between the sample and the cover glass to generate an evanescent wave. Accordingly, an objective having an NA not less than 1.38 is needed. In a case where the sample is cells in a culture solution, if an objective having an NA less than 1.38 is used, it is very difficult to carry out total reflection illumination from the objective side.

Conversely, to observe an interference reflection microscopic image with high contrast, the totally reflected component of illuminating light has to be cut off. In this case, an interference reflection microscopic image of high contrast cannot be observed unless illumination is carried out at an NA less than 1.38.

In view of the above-described circumstances, an objective having an NA not less than 1.4 is needed to perform microscopic observation in such a way that the sample is first observed under fluorescence illumination, and then the observation mode is switched to observe the sample under illumination with an evanescent wave.

Accordingly, an objective having an NA not less than 1.4 is used in the present invention. It should be noted that if an objective having an NA not less than 1.41 is used, observation under each of total internal reflection fluorescence microscopy, fluorescence microscopy and interference reflection microscopy can be performed favorably by switching between NA values of the illuminating optical system.

It should be noted that the numerical aperture (NA) of microscope objectives can be increased to about 2.0 at maximum. If this numerical aperture value is exceeded, vitreous materials usable in design and substances usable as immersion oil will be limited considerably. As a result, it will become difficult to increase the transmittance of the objective over a wide range and will become impossible to increase the transmittance of the immersion oil.

Embodiments of the present invention will be described below with reference to the accompanying drawings.

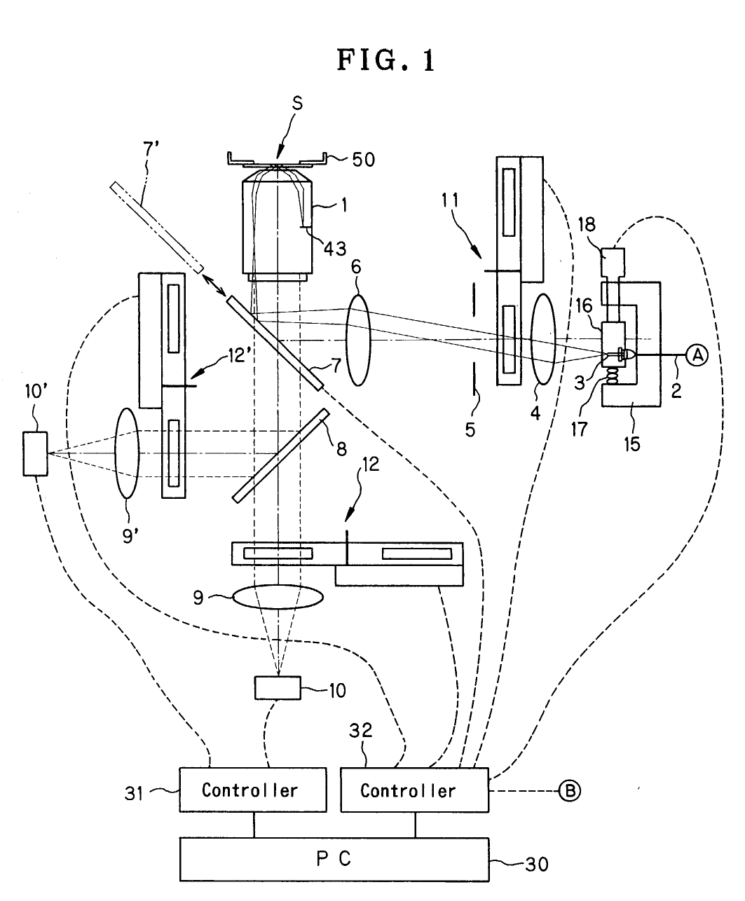

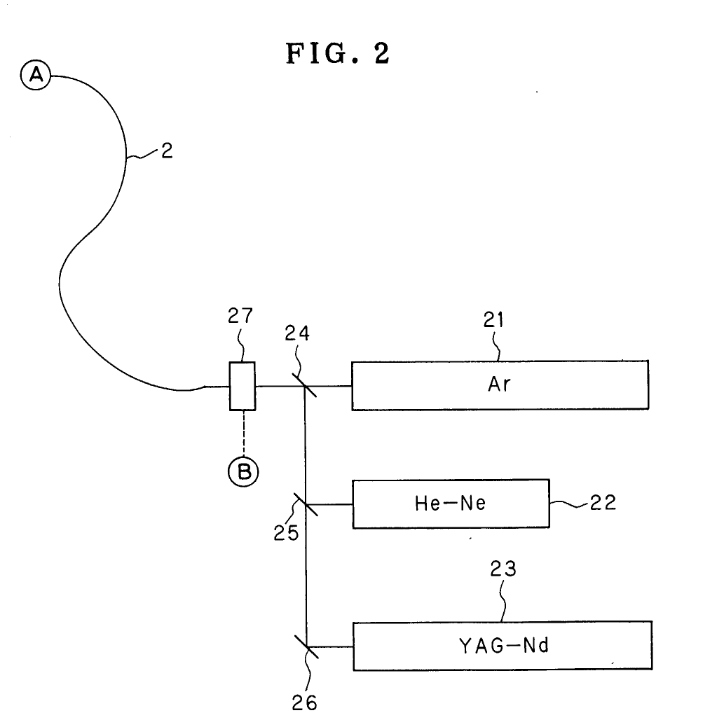

FIG. 1 shows the arrangement of a microscope system according to a first embodiment of the present invention. FIG. 2 shows the arrangement of a light source unit for use in the first embodiment. In this embodiment, a laser beam is used as illuminating light. A laser beam as illuminating light is emitted from an exit end 3 of a single-mode optical fiber 2. The laser light passes through a collector lens 4, a field stop 5 and an illuminating lens 6 and is incident on a dichroic mirror 7 diagonally disposed in the viewing optical path of an inverted microscope. The laser beam reflected by the dichroic mirror 7 enters an objective 1 to illuminate a sample S, which is put in a Petri dish (laboratory dish) 50 placed above the objective 1, from below the sample S. Fluorescence emitted from the sample S enters the objective 1 and then passes through the dichroic mirror 7. The fluorescence further passes through a dichroic mirror 8 and enters an image-forming lens 9 to form a fluorescence image of the sample S on an image pickup device 10. Light reflected by the dichroic mirror 8 enters an image-forming lens 9′ to form a fluorescence image of the sample S on another image pickup device 10′. It should be noted that a CCD, a SIT tube, a CCD with image intensifier, etc. may be used as the image pickup device 10. If half-mirrors 7′ and 8 are used in place of the dichroic mirrors 7 and 8, observation can be performed with light scattered from the surface of the sample S. It is also possible to obtain an interference image. The dichroic mirror 7 reflects the wavelength of illuminating light (excitation light) and transmits the wavelength of fluorescence emitted from the sample S.

In the above-described arrangement, the exit end 3 of the optical fiber 2 is disposed substantially in the front focal plane of the collector lens 4. Light emitted from the exit end 3 is collected (imaged) on the pupil plane of the objective 1 through the illuminating lens 6. The focal lengths of the collector lens 4 and the illuminating lens 6 and the positions of the collector lens 4, the illuminating lens 6, the field stop 5 and the objective 1 are determined so that an image of the field stop 5 is formed on the surface of the sample S.

The exit end 3 of the optical fiber 2 is secured to a moving member 16. The moving member 16 is disposed in a fixed frame 15 having a U-shaped cross-section. The moving member 16 is held between one end of an expansion spring 17 and the distal end of an adjust screw 18 within the fixed frame 15. Accordingly, as it is rotated, the adjust screw 18 itself moves in a direction perpendicular to the optical axis of the illuminating system. As the adjust screw 18 moves, the moving member 16 moves. Consequently, it is possible to adjust the position of the exit end 3 of the optical fiber 2 in the direction perpendicular to the illuminating system optical axis.

An end of the optical fiber 2 opposite to the exit end 3 is connected to a light source unit as shown in FIG. 2. The light source unit has three lasers: an Ar laser 21 for generating light of wavelength 488 nm; a He—Ne laser 22 for generating light of wavelength 548 nm; and a YAG-Nd laser 23 for generating light of wavelength 532 nm. The laser beams of three different wavelengths are combined into a single light beam by a mirror 26 that reflects light of wavelength 532 nm, a dichroic mirror 25 that transmits light of wavelength 532 nm and reflects light of wavelength 548 nm, and a dichroic mirror 24 that transmits light of wavelength 488 nm and reflects light of wavelength 532 to 548 nm. The composite laser beam enters an AOTF (Acousto-Optic Tunable Filter) 27. It should be noted that a wavelength of laser beam to be coupled to the optical fiber 2 is selected by controlling the AOTF 27. The AOTF 27 can also function as a shutter.

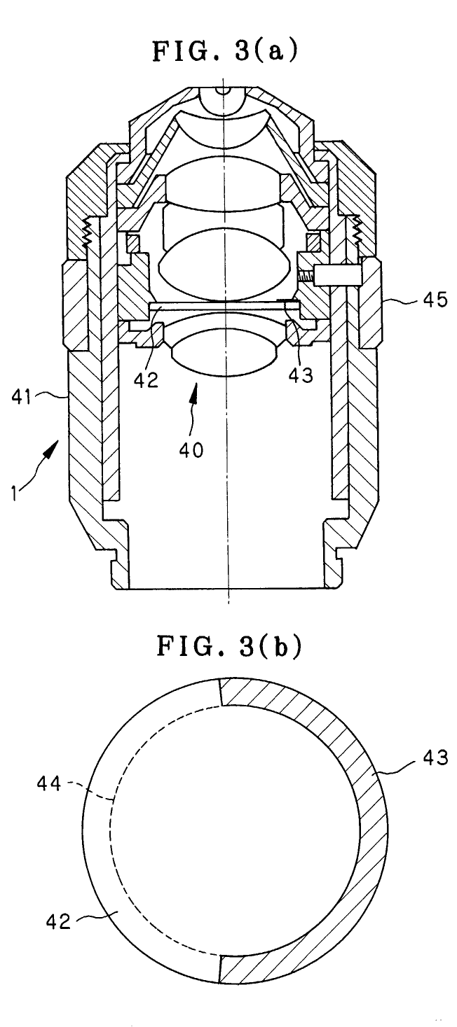

As shown in FIG. 3(a), the objective 1 has a microscope objective lens 40 with an NA of 1.43, for example. The microscope objective lens 40 is held in an objective barrel (lens barrel) 41. A glass plate 42 as shown in FIG. 3(b) is mounted in the vicinity of the back focal plane of the microscope objective lens 40 in such a manner that the glass plate 42 is rotatable about the optical axis to make adjustment. The glass plate 42 is provided with a light-shielding film 43 over a region extending in excess of a half of the circumference outside a position 44 at which the NA of the microscope objective lens 40 is 1.38. The position of the light-shielding film 43 can be changed by turning a rotary ring 45 provided on the outer periphery of the objective barrel 41. It should be noted that examples of films usable as the light-shielding film 43 are a light-absorbing film and a light-reflecting film. The light-absorbing film is preferable.

A filter wheel 11 is disposed in an illuminating optical path extending from the exit end 3 of the optical fiber 2 to the dichroic mirror 7 (in the case of FIG. 1, the filter wheel 11 is disposed between the collector lens 4 and the field stop 5). Filter wheels 12 and 12′ are disposed in respective viewing optical paths extending from the dichroic mirror or half-mirror 8 to the image pickup devices 10 and 10′ (in the case of FIG. 1, the filter wheels 12 and 12′ are disposed on the respective entrance sides of the image-forming lenses 9 and 9′). Filters placed in the filter wheels 11, 12 and 12′ so as to be selectively insertable into the associated optical paths will be described later.

In the above-described arrangement, the image pickup devices 10 and 10′ are controlled by a controller 31 connected to a personal computer 30. Another controller 32 connected to the personal computer 30 performs positional adjustment of the exit end 3 of the optical fiber 2, makes selection of filters from the filter wheels 11, 12 and 12′, switches between the dichroic mirror 7 and the half-mirror 7′, and controls the AOTF 27. More specifically, the position of the exit end 3 of the optical fiber 2 can be continuously moved between a position where illuminating light is totally reflected at the sample S side interface of a cover glass provided on the bottom of the Petri dish 50 (this position will hereinafter be referred to as “total reflection illuminating position”) and a position where illuminating light passes through the sample S (this position will hereinafter be referred to as “transmission illuminating position”) by turning the adjust screw 18 with a motor or the like (not shown) through the controller 32. In addition, the dichroic mirror 7 and the half-mirror 7′ are switched from one to the other through the controller 32 or by a manual operation. It is also possible to select a wavelength of laser beam to be used for illumination by controlling the AOTF 27 through the controller 32. Further, band-pass filters used for observation can be selected by rotating the filter wheels 12 and 12′ through the controller 32 or a manual operation. It is also possible to insert a diffuser (frosted plate) or a shutter into the illuminating optical path by rotating the filter wheel 11 through the controller 32 or a manual operation.

With the above-described arrangement, the operation of the microscope system under total internal reflection fluorescence microscopy, fluorescence microscopy and interference reflection microscopy (or reflection contrast microscopy) and switching between the observation modes are made as follows.

To observe a total internal reflection fluorescence microscopic image, first, a wavelength of laser beam to be used for illumination is selected by controlling the AOTF 27. Then, the position of the exit end 3 of the optical fiber 2 is moved to the total reflection illuminating position. The dichroic mirror 7 is inserted to introduce illuminating light into the viewing optical paths. Further, band-pass filters that transmit the fluorescence wavelength are selected and inserted into the respective viewing optical paths by rotating the filter wheels 12 and 12′. In a case where fluorescence images observed with the image pickup devices 10 and 10′ are different in wavelength from each other, a band-pass filter selected from the filter wheel 12 and a band-pass filter selected from the filter wheel 12′ are different from each other in the band of wavelengths transmitted.

When the position of the exit end 3 of the optical fiber 2 is adjusted to the total reflection illuminating position as stated above, a light beam emitted from the exit end 3 passes through the collector lens 4, the field stop 5 and the illuminating lens 6 and is reflected by the dichroic mirror 7 to form an image in the vicinity of a position of NA 1.38 or more at the outermost periphery of the pupil of the objective 1 (outside the position 44 of the glass plate 42). The light beam passes through the transmitting portion of the glass plate 42 and is formed into an approximately parallel beam through the microscope objective lens 40. The light beam exits the objective 1 at an angle at which it is totally reflected at the sample S side interface of the cover glass provided on the bottom of the Petri dish 50. The totally reflected light enters the objective 1 in which it is imaged on the light-shielding film 43 of the glass plate 42 through the microscope objective lens 40 and thus cut off. Accordingly, the totally reflected light does not become noise light that reduces the contrast of the fluorescence image under observation. Meanwhile, an evanescent wave generated by the total reflection illuminates the vicinity of the surface of the sample S. Consequently, fluorescence is emitted from a region of the sample S illuminated with the evanescent wave. The fluorescent light exits the objective 1 without being cut off by the light-shielding film 43 on the glass plate 42. Then, the fluorescent light passes through the dichroic mirror 7 and is split into two light beams by the dichroic mirror 8. The light beams pass through the respective band-pass filters in the filter wheels 12 and 12′ and form total internal reflection fluorescence microscopic images on the image pickup devices 10 and 10′, respectively. The images are picked up and recorded under the control of the controller 31.

To obtain an interference reflection microscopic image, a wavelength of laser beam to be used for the illumination of interference reflection microscopy is selected by controlling the AOTF 27. The position of the exit end 3 of the optical fiber 2 is adjusted to the transmission illuminating position, that is, to a position at which the NA of illumination is about 1.2 or less. To introduce illuminating light into the viewing optical paths, the half-mirror 7′ is inserted. In addition, band-pass filters that transmit the illuminating light are selected and inserted into the respective viewing optical paths by rotating the filter wheels 12 and 12′.

When the position of the exit end 3 of the optical fiber 2 is adjusted to the transmission illuminating position as stated above, the light beam emitted from the exit end 3 passes through the collector lens 4, the field stop 5 and the illuminating lens 6 and is reflected by the half-mirror 7′ to form an image at a position of NA about 1.2 or less on the pupil of the objective 1. The light beam passes through the transmitting portion in the center of the glass plate 42 and is formed into an approximately parallel beam through the microscope objective lens 40. The light beam is partly reflected at the sample S side interface of the cover glass provided on the bottom of the Petri dish 50. The rest of the light beam passes through the cover glass and is reflected at the surface of the sample S. Both the reflected light beams enter the objective 1 again and exit therefrom without being cut off by the light-shielding film 43. Then, the light passes through the half-mirror 7′ and is split into two light beams by the half-mirror 8. The light beams pass through the respective band-pass filters in the filter wheels 12 and 12′ and form interference reflection microscopic images on the image pickup devices 10 and 10′, respectively. The images are picked up and recorded under the control of the controller 31. It should be noted that if the half-mirror 8 is removed, bright interference reflection microscopic images can be obtained.

To obtain a fluorescence microscopic image, a wavelength of laser beam to be used for the illumination of fluorescence microscopy is selected by controlling the AOTF 27. The position of the exit end 3 of the optical fiber 2 is adjusted to the transmission illuminating position. However, the transmission illuminating position is different from that in the interference reflection microscopy. That is, the position of the exit end 3 of the optical fiber 2 is adjusted to an angle position at which illuminating light is not totally reflected but reaches the sample S directly at an NA of 1.38 or less. To introduce illuminating light into the viewing optical paths, the dichroic mirror 7 is inserted. In addition, band-pass filters that transmit the fluorescence wavelength are selected and inserted into the respective viewing optical paths by rotating the filter wheels 12 and 12′. In a case where fluorescence images observed with the image pickup devices 10 and 10′ are different in wavelength from each other, a band-pass filter selected from the filter wheel 12 and a band-pass filter selected from the filter wheel 12′ are different from each other in the band of wavelengths transmitted.

When the position of the exit end 3 of the optical fiber 2 is adjusted to the transmission illuminating position as stated above, a light beam emerging from the exit end 3 passes through the collector lens 4, the field stop 5 and the illuminating lens 6 and is reflected by the dichroic mirror 7 to form an image at a position of NA 1.38 or less on the pupil of the objective 1. The light beam passes through the transmitting portion in the center of the glass plate 42 and is formed into an approximately parallel beam through the microscope objective lens 40. The light beam passes through the sample S. Thus, fluorescence is emitted from the illuminated region of the sample S. The fluorescence exits the objective 1 without being cut off by the light-shielding film 43 on the glass plate 42. Then, the fluorescent light passes through the dichroic mirror 7 and is split into two light beams by the dichroic mirror 8. The light beams pass through the respective band-pass filters in the filter wheels 12 and 12′ and form fluorescence microscopic images on the image pickup devices 10 and 10′, respectively. The images are picked up and recorded under the control of the controller 31.

It should be noted that to observe the surface of the sample S under the fluorescence microscopy over a range thicker than in the case of evanescent waves and thinner than in the case of ordinary fluorescence images, the NA of illuminating light should be restricted within a limited zonal range of NA close to 1.38. By doing so, illuminating light emerging from the cover glass on the bottom of the Petri dish 50 to the sample S side is allowed to be at an angle close to 90 degrees with respect to the optical axis.

The microscope system arranged as stated above may adopt another method of readily switching between the fluorescence microscopic image and the total internal reflection fluorescence microscopic image or the interference reflection microscopic image. That is, a diffuser (frosted plate) has previously been provided in the filter wheel 11, and the frosted plate is inserted into the illuminating optical path under the illuminating conditions for obtaining a total internal reflection fluorescence microscopic image or an interference reflection microscopic image, thereby allowing a fluorescence microscopic image to be observed. More specifically, the frosted plate diffuses the laser beam emitted from the exit end 3 of the optical fiber 2. Therefore, when the frosted plate is inserted into the illuminating optical path for obtaining a total internal reflection fluorescence microscopic image or an interference reflection microscopic image, the laser beam is diffused by the frosted plate so as to pass through the entire pupil area of the objective 1, thus providing fluorescence illumination. When the frosted plate is removed from the optical path, it is possible to provide illumination for total internal reflection fluorescence microscopy or for interference reflection microscopy. The frosted plate may be mounted in the vicinity of the dichroic mirror 7 so as to be selectively inserted into or removed from the optical path together with the dichroic mirror 7, instead of being provided in the filter wheel 11. The frosted plate as mounted in this way provides the same function as the above.

The dichroic mirror 7, the half-mirror 7′ and the band-pass filters inserted into the viewing optical paths by the filter wheels 12 and 12′, which are necessary for observation, need to be changed for each observation mode, i.e. fluorescence microscopy, total internal reflection fluorescence microscopy, and interference reflection microscopy. Therefore, it is preferable that the dichroic mirror 7 and the half-mirror 7′ should be made electrically movable, and the filter wheels 12 and 12′should also be made electrically rotatable. By doing so, various observation modes can be switched from one to another very easily.

It is also preferable in the arrangement shown in FIG. 1 that microscopic image observation procedures and an observation mode switching procedure should have previously been input to the personal computer 30. By doing so, various observation modes can be automatically switched from one to another through the controllers 31 and 32 to observe and record various microscopic images.

It should be noted that the light-shielding film 43 provided in the objective 1 may be formed by a coating applied to a region of the glass plate 42 extending in excess of a half of the circumference at which the NA of the microscope objective lens 40 is 1.38 or more. However, it is also possible to use a stop member with a similar configuration made from a metal plate, in place of the light-shielding film 43. The light-shielding film 43 or the stop member need not always be capable of completely cutting off the totally reflected return light. If at least about 70% of the totally reflected return light can be cut off, the totally reflected light attenuates considerably, so that an image of high contrast can be obtained. The light-shielding film 43 or the stop member should preferably have a rotary adjusting mechanism as shown in FIG. 3(a). The rotary adjusting mechanism allows the position of the light-shielding part to be adjusted in accordance with the direction of incidence of illuminating light, conveniently.

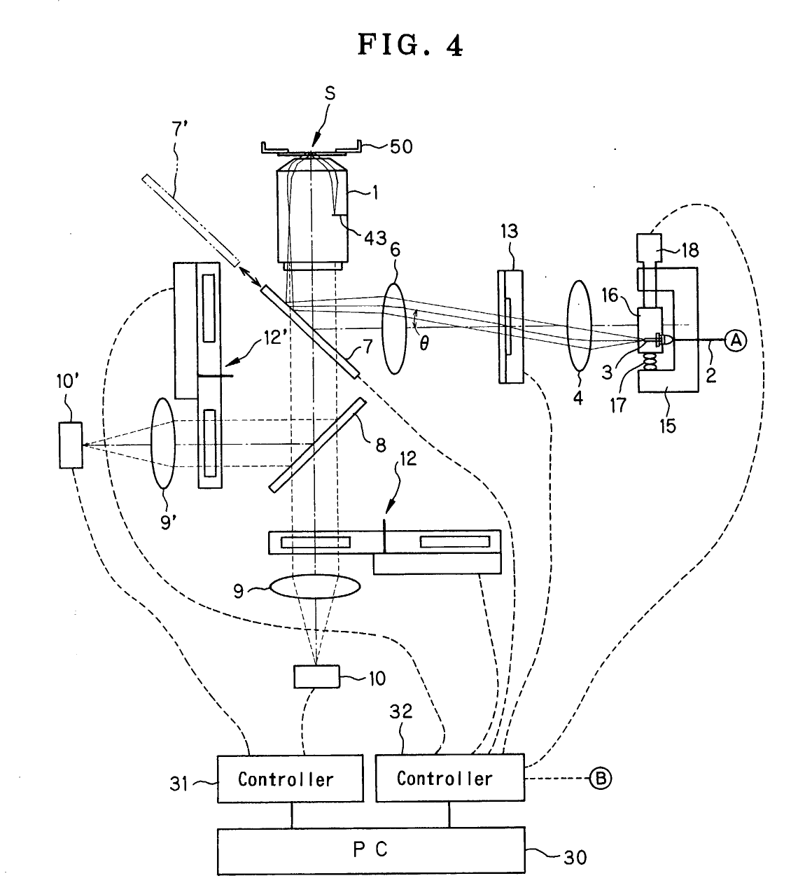

FIG. 4 is a diagram showing the arrangement of a microscope system according to a second embodiment of the present invention. The second embodiment is a modification of the first embodiment, which is shown in FIG. 1. The second embodiment differs from the first embodiment in that the filter wheel 11 and the field stop 5, which are used in the first embodiment, are omitted in the second embodiment. An AOTF or an AOM (Acousto-Optic Modulator) 13 is placed at the position of the field stop 5 (in the vicinity of a position conjugate to the surface of the sample S and coincident with the front focal point of the illuminating lens 6). The operation of the AOTF or AOM 13 is controlled by the controller 32. The rest of the second embodiment is the same as in the case of FIGS. 1 to 3.

In this embodiment, the imagery position of illuminating light on the pupil plane of the objective 1 is controlled by electrically varying the angle θ of deflection of illuminating light by the AOTF or AOM 13. It is a matter of course that the imagery position control may be effected jointly with the adjustment of the position of the exit end 3 of the optical fiber 2 with respect to the optical axis of the illuminating system. By controlling the deflection angle θ of the light beam emerging from the AOTF or AOM 13, the NA at the imagery position of illuminating light emitted from the exit end 3 can be adjusted to not less than or less than 1.38 to select any one of fluorescence illumination, total internal reflection fluorescence illumination, and interference reflection illumination. In this case, the AOTF or AOM 13 can be used as a shutter as well. However, to observe a fluorescence microscopic image under the illuminating conditions for obtaining a total internal reflection fluorescence microscopic image or an interference reflection microscopic image in this embodiment, the microscope system should be arranged so that a frosted plate can be inserted at the exit side of the AOTF or AOM 13.

In the foregoing, embodiments arranged to control the NA of illuminating light when a laser beam is used as the illuminating light have been described. The following is a description of embodiments using a light source other than lasers, e.g. a high-pressure mercury lamp, a high-pressure xenon lamp, a xenon-mercury lamp, a halogen lamp, or a metal halide lamp, i.e. a white light source. Even when such a light source is used, the NA of illuminating light can be controlled.

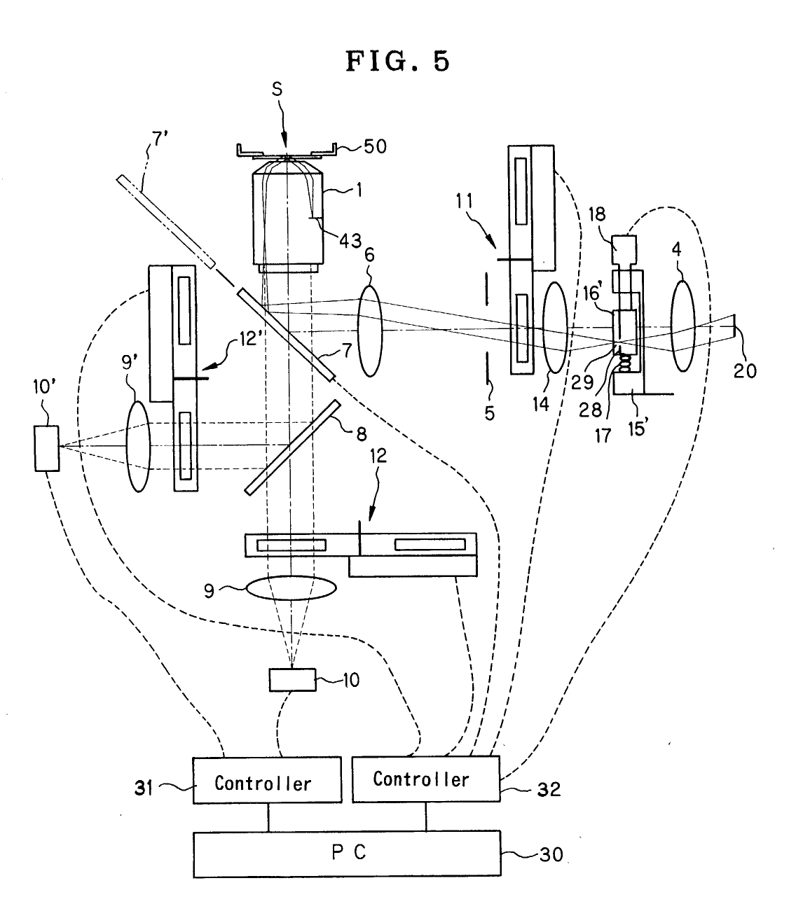

FIG. 5 is a diagram showing the arrangement of a microscope system according to a third embodiment of the present invention. The third embodiment is the same as the first embodiment, which is shown in FIG. 1, except for the illuminating system. White illuminating light emitted from a white light source 20 such as that stated above is collected through the collector lens 4. A stop plate 28 is disposed at a position where the illuminating light is collected. The stop plate 28 is arranged so that the position thereof is adjustable in a direction perpendicular to the optical axis of the illuminating system. Illuminating light passing through an aperture 29 of the stop plate 28 passes through a projection lens 14, a field stop 5 and an illuminating lens 6 and is then reflected by a dichroic mirror 7 to enter an objective 1. The illuminating light illuminates a sample S, which is put in a Petri dish 50 placed above the objective 1, from below the sample S. Fluorescence emitted from the sample S enters the objective 1 and passes through the dichroic mirror 7 and further through a dichroic mirror 8 to enter an image-forming lens 9, thus forming a fluorescence image of the sample S on an image pickup device 10. Light reflected by the dichroic mirror 8 enters another image-forming lens 9′ and forms a fluorescence image of the sample S on another image pickup device 10′. It should be noted that if a half-mirror 7′ is used and the dichroic mirror 8 is changed to a half-mirror, observation can be performed with light scattered from the surface of the sample S. It is also possible to obtain an interference image.

In the above-described arrangement, the stop plate 28 is disposed substantially in the front focal plane of the projection lens 14. Light emerging from the aperture 29 of the stop plate 28 is collected (imaged) on the pupil plane of the objective 1 through the illuminating lens 6. The focal lengths of the projection lens 14 and the illuminating lens 6 and the positions of the collector lens 4, the illuminating lens 6, the field stop 5 and the objective 1 are determined so that an image of the field stop 5 is formed on the surface of the sample S.

The stop plate 28 is secured to a transparent moving member 16′. The transparent moving member 16′ is disposed in a fixed frame 15′ having a U-shaped cross-section. The fixed frame 15′ is transparent or has an aperture at a portion thereof facing in the direction of the optical axis. The transparent moving member 16′ is held between one end of an expansion spring 17 and the distal end of an adjust screw 18 within the fixed frame 15′. Accordingly, as it is rotated, the adjust screw 18 itself moves in a direction perpendicular to the optical axis of the illuminating system. As the adjust screw 18 moves, the transparent moving member 16′ moves. Consequently, it is possible to adjust the position of the aperture 29 of the stop plate 28 in the direction perpendicular to the illuminating system optical axis.

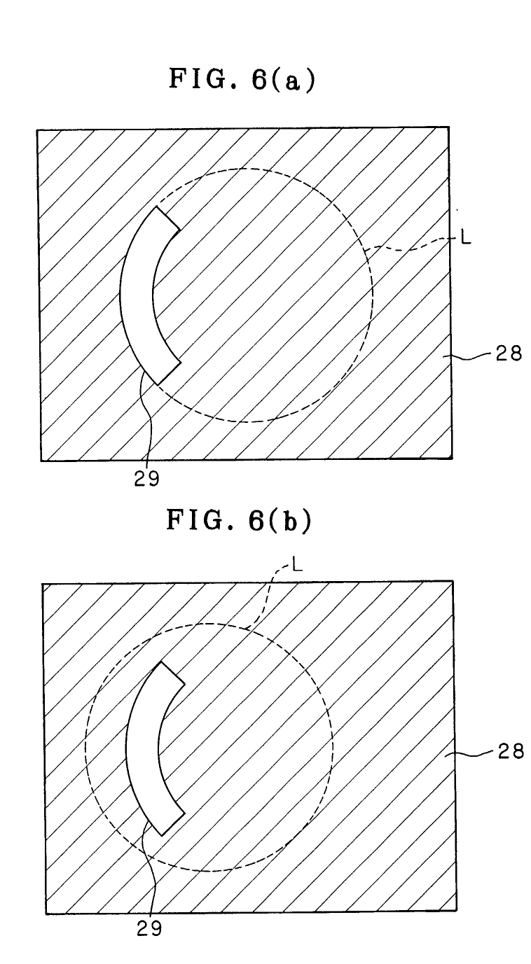

As shown in FIGS. 6(a) and 6(b), the aperture 29 provided in the stop plate 28 is in the shape of a circular arc extending over an angle less than 180 degrees. The radius of the outer periphery of the aperture 29 is set approximately equal to the radius of the outer periphery L of the illuminating area of the illuminating system. Accordingly, the position of the aperture 29 as imaged on the pupil plane of the objective 1 can be made to differ as shown in FIGS. 6(a) and 6(b) by turning the adjust screw 18 through the controller 32 to adjust the position of the stop plate 28 in a direction perpendicular to the optical axis of the illuminating system. FIG. 6(a) shows a state where the aperture 29 is imaged in the vicinity of a position of NA 1.38 or more at the outermost periphery of the pupil of the objective 1 (outside the position 44 of the glass plate 42). FIG. 6(b) shows a state where the aperture 29 is imaged in the vicinity of a position of NA 1.38 or less of the pupil of the objective 1 (inside the position 44 of the glass plate 42). Thus, the position on the pupil plane where the aperture 29 is imaged can be selectively adjusted.

In this embodiment, a wavelength selecting filter (band-pass filter) for selecting a wavelength of illuminating light needs to be placed in the illuminating optical path no matter which of fluorescence and interference images is to be observed, because the white light source 20 is used as an illuminating light source. More specifically, a filter wheel 11 is placed in an illuminating optical path extending from the stop plate 28 to the dichroic mirror 7 or the half-mirror 7′ to select and insert such a wavelength selecting filter into the optical path (in the arrangement shown in FIG. 5, the filter wheel 11 is positioned between the projection lens 14 and the field stop 5).

With the above-described arrangement, the operation of the microscope system under total internal reflection fluorescence microscopy, fluorescence microscopy and interference reflection microscopy (or reflection contrast microscopy) and switching between the observation modes are made as follows.

To observe a total internal reflection fluorescence microscopic image, first, a wavelength of illuminating light to be used for illumination is selected by controlling the filter wheel 11. Then, the position of the aperture 29 of the stop plate 28 is moved to a position where illuminating light is totally reflected at the sample S side interface of a cover glass provided on the bottom of the Petri dish 50. A dichroic mirror 7 is inserted to introduce illuminating light into the viewing optical paths. The dichroic mirror 7 reflects the wavelength of illuminating light (excitation light) and transmits the wavelength of fluorescence emitted from the sample S. Further, band-pass filters that transmit the fluorescence wavelength are selected and inserted into the respective viewing optical paths by rotating the filter wheels 12 and 12′. In a case where fluorescence images observed with the image pickup devices 10 and 10′ are different in wavelength from each other, band-pass filters are selected from the filter wheels 12 and 12′ according to the wavelengths of the fluorescence images so as to be different from each other in the band of wavelengths transmitted.

When the position of the aperture 29 of the stop plate 28 is adjusted to move to the position for total internal reflection fluorescence microscopy, a light beam emerging from the aperture 29 of the stop plate 28 passes through the projection lens 14, the field stop 5, a wavelength selecting filter in the filter wheel 11, the illuminating lens 6 and is reflected by the dichroic mirror 7 to form an image in the vicinity of a position of NA 1.38 or more at the outermost periphery of the pupil of the objective 1 (outside the position 44 of the glass plate 42). The light beam passes through the transmitting portion of the glass plate 42 and is formed into an approximately parallel beam through the microscope objective lens 40. The light beam exits the objective 1 at an angle at which it is totally reflected at the sample S side interface of the cover glass provided on the bottom of the Petri dish 50. The totally reflected light enters the objective 1 in which it is imaged on the light-shielding film 43 of the glass plate 42 through the microscope objective lens 40 and thus cut off. Accordingly, the totally reflected light does not become noise light that reduces the contrast of the fluorescence image under observation. Meanwhile, an evanescent wave generated by the total reflection at the sample S side interface of the cover glass on the bottom of the Petri dish 50 illuminates thinly the surface of the sample S. Consequently, fluorescence is emitted from a region of the sample S illuminated with the evanescent wave. The fluorescent light passes through the objective 1 without being cut off by the light-shielding film 43 on the glass plate 42. Then, the fluorescent light passes through the dichroic mirror 7 and is split into two light beams by the dichroic mirror or half-mirror 8. The light beams pass through the respective band-pass filters in the filter wheels 12 and 12′ selected according to the fluorescence wavelength to be observed and form total internal reflection fluorescence microscopic images on the image pickup devices 10 and 10′, respectively. The images are picked up and recorded under the control of the controller 31.

To obtain an interference reflection microscopic image, a wavelength of illuminating light to be used for the illumination of interference reflection microscopy is selected by controlling the filter wheel 11. The position of the aperture 29 of the stop plate 28 is adjusted so that illuminating light passes through the sample S. That is, the position of the aperture 29 of the stop plate 28 is adjusted to a position at which the NA of illumination is about 1.2 or less. To introduce illuminating light into the viewing optical paths, the half-mirror 7′ is inserted. In addition, band-pass filters that transmit the illuminating light are selected and inserted into the respective viewing optical paths by rotating the filter wheels 12 and 12′.

When the position of the aperture 29 of the stop plate 28 is adjusted to move to the position for interference reflection microscopy as stated above, the light beam emerging from the aperture 29 of the stop plate 28 passes through the projection lens 14, the field stop 5, a wavelength selecting filter in the filter wheel 11, the illuminating lens 6 and is reflected by the half-mirror 7′ to form an image at a position of NA about 1.2 or less on the pupil of the objective 1. The light beam passes through the transmitting portion in the center of the glass plate 42 and is formed into an approximately parallel beam through the microscope objective lens 40. The light beam is partly reflected at the sample S side interface of the cover glass provided on the bottom of the Petri dish 50. The rest of the light beam passes through the cover glass and is reflected at the surface of the sample S. Both the reflected light beams enter the objective 1 again and pass therethrough without being cut off by the light-shielding film 43. Then, the light passes through the half-mirror 7′ and is split into two light beams by the dichroic mirror or half-mirror 8. The light beams pass through respective band-pass filters in the filter wheels 12 and 12′ that transmit only the corresponding reflected light beams, and form interference reflection microscopic images on the image pickup devices 10 and 10′, respectively. The images are picked up and recorded under the control of the controller 31.

To obtain a fluorescence microscopic image, a wavelength of illuminating light to be used for the illumination of fluorescence microscopy is selected by controlling the filter wheel 11. The position of the aperture 29 of the stop plate 28 is adjusted to an angle position at which illuminating light is not totally reflected but reaches the sample S directly at an NA of 1.38 or less. A dichroic mirror 7 is inserted to introduce illuminating light into the viewing optical paths. The dichroic mirror 7 reflects the wavelength of illuminating light (excitation light) and transmits the wavelength of fluorescence emitted from the sample S. Further, band-pass filters that transmit the fluorescence wavelength are selected and inserted into the respective viewing optical paths by rotating the filter wheels 12 and 12′. In a case where fluorescence images observed with the image pickup devices 10 and 10′ are different in wavelength from each other, band-pass filters are selected from the filter wheels 12 and 12′ according to the wavelengths of the fluorescence images so as to be different from each other in the band of wavelengths transmitted.

When the position of the aperture 29 of the stop plate 28 is adjusted to move to the position for fluorescence microscopy as stated above, a light beam emerging from the aperture 29 of the stop plate 28 passes through the projection lens 14, the field stop 5, a wavelength selecting filter in the filter wheel 11, and the illuminating lens 6 and is reflected by the dichroic mirror 7 to form an image at a position of NA 1.38 or less on the pupil of the objective 1. The light beam passes through the transmitting portion in the center of the glass plate 42 and is formed into an approximately parallel beam through the microscope objective lens 40. The light beam passes through the sample S. Thus, fluorescence is emitted from the illuminated region of the sample S. The fluorescence passes through the objective 1 without being cut off by the light-shielding film 43 on the glass plate 42. Then, the fluorescent light passes through the dichroic mirror 7 and is split into two light beams by the dichroic mirror or half-mirror 8. The light beams pass through the respective band-pass filters in the filter wheels 12 and 12′ selected according to the fluorescence wavelength to be observed and form fluorescence microscopic images on the image pickup devices 10 and 10′, respectively. The images are picked up and recorded under the control of the controller 31.

It should be noted that to observe the surface of the sample S under the fluorescence microscopy over a range thicker than in the case of evanescent waves and thinner than in the case of ordinary fluorescence images, the NA of illuminating light should be made close to 1.38, whereby illuminating light emerging from the cover glass on the bottom of the Petri dish 50 to the sample S side is readily allowed to be at an angle close to 90 degrees with respect to the optical axis.

The microscope system arranged as stated above may adopt another method for readily switching between the fluorescence microscopic image and the total internal reflection fluorescence microscopic image or the interference reflection microscopic image. That is, a wavelength selecting filter provided with a diffuser (frosted plate) has previously been provided in the filter wheel 11, and at the position for total internal reflection fluorescence microscopy or interference reflection microscopy, the wavelength selecting filter so far used is switched to the frosted wavelength selecting filter by operating the filter wheel 11, thereby allowing a fluorescence microscopic image to be observed. More specifically, the frosted plate diffuses illuminating light used in the position for observing a total internal reflection fluorescence microscopic image or an interference reflection microscopic image. Therefore, when the frosted wavelength selecting filter is inserted into the illuminating optical path, the illuminating light is diffused by the frosted plate so as to illuminate the entire pupil area of the objective 1, thus providing fluorescence illumination. When the frosted wavelength selecting filter is switched to a non-frosted wavelength selecting filter, it is possible to provide illumination for total internal reflection fluorescence microscopy or for interference reflection microscopy. The frosted plate may be mounted in the vicinity of the dichroic mirror 7 so as to be selectively inserted into or removed from the optical path together with the dichroic mirror 7, instead of being provided in the filter wheel 11. The frosted plate as mounted in this way provides the same function as the above.

The dichroic mirror 7, the half-mirror 7′ and the band-pass filters inserted into the viewing optical paths by the filter wheels 12 and 12′, which are necessary for observation, need to be changed for each observation mode, i.e. fluorescence microscopy, total internal reflection fluorescence microscopy, and interference reflection microscopy. Therefore, it is preferable that the dichroic mirror 7 and the half-mirror 7′ should be made electrically movable, and the band-pass filters should be made switchable by electrically moving the filter wheels 12 and 12′. By doing so, various observation modes can be switched from one to another very easily.

Next, a fourth embodiment of the present invention will be described. In this embodiment, the microscope system is arranged to prevent the microscopic image under observation from coming out of focus owing to changes in temperature of the outside air or the like when changes of the sample S with time are observed by various observation methods as stated above.

In observation of changes of the sample S with time, it is very important to produce a favorable environment for cells by controlling the temperature of the culture solution and the gas. Accordingly, to observe changes of the sample S with time by various observation methods, the objective 1 is mounted on a mechanical component for holding the sample S.

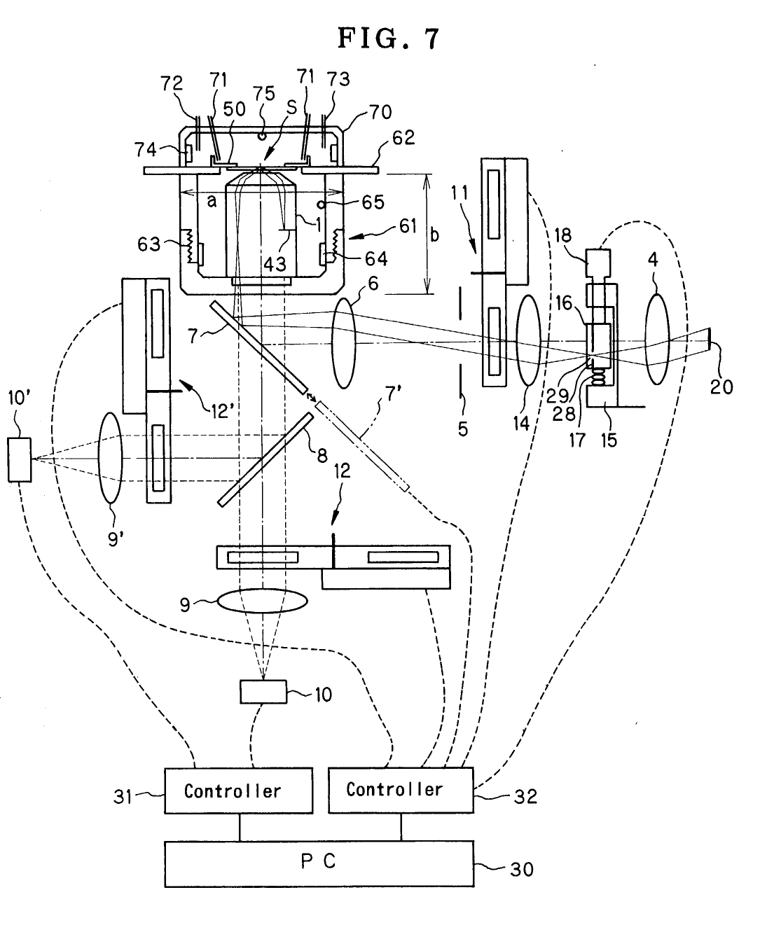

FIG. 7 is a diagram showing the arrangement of a microscope system according to this embodiment. In FIG. 7, the illuminating and viewing systems of the microscope adopt the arrangement using the white light source 20 as shown in FIG. 5. However, it is also possible to adopt the arrangement shown in FIGS. 1 or 4. In this embodiment, the microscope system has a mechanical component 61 in the shape of a cylinder, one end of which is closed. The objective 1 is integrally and coaxially fitted into the inner side of the bottom of the mechanical component 61 at a fitting portion at the rear end thereof. The mechanical component 61 is, although not shown, secured to the microscope body as one unit. The length b of the mechanical component 61 is set in the range of from 30% to 160% of the overall length of the objective 1. The diameter a of the mechanical component 61 is set in the range of from 1.2 to 6 times the diameter of the objective 1. With such a compact size, the mechanical component 61 is easy to mount on the microscope. A sample holder 62 for holding a sample S is integrally secured to the mechanical component 61 to extend over an opening opposite to the bottom of the mechanical component 61. A thread adjusting mechanism 63 is provided in an intermediate portion of the mechanical component 61 to allow focusing of the sample S placed on the sample holder 62.

A heater 64 and a temperature sensor 65 are provided in the cylindrical mechanical component 61, thereby allowing the temperature in the mechanical component 61 retaining the objective 1 to be kept constant.

A cup-shaped incubator 70 can be mounted on the sample holder 62 holding a Petri dish 50 containing a sample S in such a manner that the incubator 70 hermetically covers the Petri dish 50. A heater 74 and a temperature sensor 75 are provided in the incubator 70 to allow the temperature to be controlled from about 20° C. to about 40° C. so that the sample S will not be subjected to temperature changes by the outside air. It should be noted that the incubator 70 is provided with a gas inlet pipe 72 and a gas outlet pipe 73 so that the densities of CO₂ and various gases in the environment of the sample S can be controlled. Thus, it is possible to introduce gases necessary for keeping cells alive and to stimulate them with a gas. The incubator 70 is further provided with liquid pipes 71 for loading and sucking a culture solution necessary for keeping cells alive and a liquid for stimulating them.

With the above-described arrangement, the temperature of the objective 1 and the mechanical component 61 can be kept constant during observation of changes with time. In the case of an objective 1 having a high NA (NA 1.4 or more) so as to be capable of observing a total internal reflection fluorescence microscopic image, in particular, the depth of focus decreases as the NA increases. Therefore, the microscopic image under observation may come out of focus owing to temperature changes unless temperature control is performed strictly. For this reason, the strict temperature control for the surroundings of the sample S and the objective 1 is important from the optical point of view and also for the sample S.

It is also important in observation of changes of cells with time that the viewing optical systems should be automatically switchable from one to another. To observe changes with time under a manual microscope, it is necessary to perform the following operations, by way of example. The shutter of the illuminating system is opened by hand to optimize the illumination angle or the NA of illumination. A total internal reflection fluorescence microscopic image is formed and photographed with a camera. Next, the dichroic mirror so far used is switched to a dichroic mirror for fluorescence by a manual operation. Illuminating light is optimized, and the exposure time of the camera is adjusted. Then, photography is performed. Further, the angle or NA of illuminating light is changed, and the exposure time of the camera is adjusted to perform photography. These operations have to be carried out by using manual labor and are very troublesome. The user is likely to make a mistake in operation.

Accordingly, it is very important that the above-described microscope system according to the present invention should be capable of automatically performing switching between application and unapplication of illuminating light to the sample S, switching between illumination angles, switching between filters for illumination (e.g. switching between an excitation filter and a frosted plate), switching between filters for observation (e.g. switching between dichroic mirrors and between band-pass filters), and so forth according to a program via the personal computer 30. The microscope system capable of automatically performing these switching operations allows observation over a long period of time to be performed easily without making a mistake.

Although the microscope switchable between observation modes according to the present invention has been described above on the basis of some embodiments, the present invention is not limited to the foregoing embodiments but can be modified in a variety of ways.

As will be clear from the foregoing description, the microscope switchable between observation modes according to the present invention has an illuminating optical system that is provided therein with a mechanism for adjusting the illuminating light collecting position on the pupil plane of the objective optical system in a direction perpendicular to the optical axis. Moreover, the viewing optical path is provided therein with a wavelength selecting device for selecting an observation wavelength according to the illuminating light collecting position on the pupil plane of the objective optical system. Accordingly, it is possible to provide a high-performance microscope allowing total internal reflection fluorescence microscopy, fluorescence microscopy and interference reflection microscopy (or reflection contrast microscopy) to be selectively performed by using the same objective.

What we claim is:

1. A microscope switchable between observation modes, comprising:
an objective optical system;
an image-forming optical system for imaging light from a sample passing through said objective optical system onto an image pickup device; and
an optical member provided in a viewing optical path extending from said objective optical system to said image-forming optical system, said optical member reflecting illuminating light from an illuminating optical system so that the illuminating light enters said objective optical system, and said optical member allowing the light from the sample passing through said objective optical system to pass through said image-forming optical system;
wherein said illuminating optical system is provided therein with a mechanism for adjusting an illuminating light collecting position on a pupil plane of said objective optical system in a direction perpendicular to an optical axis; and
wherein said viewing optical path is provided therein with wavelength selecting means for selecting an observation wavelength according to the illuminating light collecting position on the pupil plane of said objective optical system.

2. A microscope switchable between observation modes according to claim 1, wherein total reflection return light cut-off means for cutting off totally reflected return light in total internal reflection fluorescence microscopy observation is disposed in a vicinity of the pupil plane of said objective optical system.

3. A microscope switchable between observation modes according to claim 1, wherein a light source of said illuminating light is a laser, and a laser beam from said laser is introduced into said illuminating optical system through an optical fiber, and wherein an exit end of said optical fiber is positioned in a conjugate relation to the pupil plane of said objective optical system, so that the illuminating light collecting position on the pupil plane of said objective optical system is adjusted in a direction perpendicular to the optical axis by adjusting a position of the exit end of said optical fiber in a direction perpendicular to the optical axis of said illuminating optical system.

4. A microscope switchable between observation modes according to claim 1, wherein a light source of said illuminating light is a laser, and a laser beam from said laser is introduced into said illuminating optical system through an optical fiber, and wherein an exit end of said optical fiber is positioned in a conjugate relation to the pupil plane of said objective optical system, and light deflecting means for deflecting said laser beam is disposed between the exit end of said optical fiber and said optical member, so that the illuminating light collecting position on the pupil plane of said objective optical system is adjusted in a direction perpendicular to the optical axis by adjusting an angle of deflection of said laser beam.

5. A microscope switchable between observation modes according to claim 1, wherein a light source of said illuminating light is a white light source, and an aperture of a stop plate is illuminated with illuminating light from said white light source, whereby the illuminating light from said white light source is introduced into said illuminating optical system, and wherein said stop plate is positioned in a conjugate relation to the pupil plane of said objective optical system, so that the illuminating light collecting position on the pupil plane of said objective optical system is adjusted in a direction perpendicular to the optical axis by adjusting a position of said stop plate in a direction perpendicular to the optical axis of said illuminating optical system.

6. A microscope switchable between observation modes according to claim 3, wherein means for combining together laser beams of different wavelengths from a plurality of lasers is provided at an entrance end side of said optical fiber, together with means for selecting a wavelength of laser beam to be introduced into said optical fiber from the laser beams combined together.

7. A microscope switchable between observation modes according to claim 5, wherein illuminating light wavelength selecting means for selecting a wavelength of illuminating light to be incident on said objective optical system is provided between said white light source and said optical member.

8. A microscope switchable between observation modes according to claim 1, further comprising:
a cylindrical member integrally secured to a fitting end of said objective optical system in such a manner as to surround said objective optical system;
a sample holder mounted on an end of said cylindrical member closer to a distal end of said objective optical system; and
a temperature adjusting mechanism provided in said cylindrical member.
